(19) United States
(12) Patent Application Publication
(10) Pub. No.: US 2013/0333959 A1
(43) Pub. Date: Dec. 19, 2013

(54) Steering axle for agricultural vehicles

(71) Applicant: Claas Selbstfahrende Erntemaschinen GMBH, Harsewinkel (DE)

(72) Inventors: Sebastian Wagemann, Oelde (DE); Dirk Speckamp, Hamm (DE)

(21) Appl. No.: 13/903,123

(22) Filed: May 28, 2013

(30) Foreign Application Priority Data
Jun. 13, 2012 (DE) 10 2012 011 573.3

(51) Int. Cl. B60K 7/00; B60B 35/12

(52) U.S. Cl. CPC B60K 7/0007; B60B 35/125
USPC 180/62; 301/126

(57) ABSTRACT

A steering axle is provided for agricultural vehicles having at least two drive motors for at least two land wheels on either side of the steering axle disposed next to one another substantially in the center between the land wheels. A mechanical drive train between the drive motor and the wheel hub is provided on both sides.

### CROSS-REFERENCE TO A RELATED APPLICATION

The invention described and claimed hereinbelow is also described in German Patent Application DE 10 2012 011573.3, filed on Jun. 13, 2012. This German Patent Application, subject matter of which is incorporated herein by reference, provides the basis for a claim of priority of invention under 35 U.S.C. 119(a)-(d).

### BACKGROUND OF THE INVENTION

The invention relates to a steering axle for agricultural vehicles, such as self-propelled harvesting machines, tractors and the like that are configured with at least two drive motors for at least two land wheels on either side of the steering axle, disposed next to one another substantially in the center between the land wheels, and a mechanical drive train is provide between the drive motor and the land wheel on both sides.

In commercially available steering axles for combine harvesters, large-volume radial piston motors, with direct drives disposed in the vicinity of the land wheels are used to drive the wheels. Due to the placement in the wheels, a complex and cost-intensive hydraulic connection is required.

Commercially available steering axles also are known that do not use radial piston motors. Such known steering axles alternatively utilize axial piston machines having two-stage planetary gears. A complex and breakage-prone hydraulic connection to the wheels is required in this case, as well.

Also known for use in commercially available agricultural vehicles are steering axles driven solely mechanically, wherein, due to the diverse nature of the mechanical components, such steering axles are highly complex and, therefore, not well suited for full electronic control.

For example, EP 1 466 772 B1 makes known a drive system for vehicles, in which two electric motors, as individual-wheel drive, are disposed on either side of an internal combustion engine in order to drive a generator. The two motors are connected in a non-positive manner to the steered land wheels by means of a planetary gear. As an alternative to an electric drive, the disclosure document mentions a hydraulic drive, placement laterally next to the internal combustion engine is disclosed only for electric drives. EP 1 466 772 further discloses that if hydraulic drives are used, a complex and breakage-prone hydraulic connection outwardly to the land wheels is required at the same point in this case.

### SUMMARY OF THE INVENTION

The present invention overcomes the shortcomings of known arts, such as those mentioned above.

In an embodiment, the invention provides a steering axle for agricultural vehicles, in which complex and breakage-prone lines to the wheels are avoided.

The steering axle is configured for agricultural vehicles, such as self-propelled harvesting machines, tractors and the like, with at least two drive motors for at least two land wheels on either side of the steering axle. The at least two drive motors are disposed next to one another substantially in the center between the land wheels, and a mechanical drive train between the drive motor and the land wheel is provided on both sides.

Due to the placement of the drive motors, the hydraulic connection is simplified considerably in the event that hydraulic motors are used. A complex and breakage-prone routing of lines to the land wheels is eliminated. In addition, due to the placement of the drive motors in the center, the installation space in the vicinity of the wheels is less restricted.

Further design advantages that may be necessary thereby become possible. For example, smaller wheels are used where necessary to allow a larger pendular angle or swivel angle of the axle to be achieved. In vehicles having relatively large wheels, which achieve a comparable pendular angle with height adjustment, the height of the vehicle cannot be adjusted for transport or working on the field.

The inventive connection is simplified in other drive motors as well, such as electric motors, since electric connection lines to the land wheels also are at risk of breakage and add complexity.

In an embodiment, the at least two drive motors are fastened at a common central axle body. Such a central axis body (which can be in the form of a housing, for example), carries both drive motors. Due to the placement in the center between the land wheels, such a central axle body holds motors on both sides. In the event that the central axle body is designed in the shape of a housing, the at least two drive motors are at least partially accommodated in the interior of the central axle body in a manner protected against contamination and external mechanical loads.

An intermediate flange is provided as a mounting flange between at least one drive motor and the central axle body. Such an intermediate flange, as a fastening element or a support element of the drive motor simplifies installation.

Preferably, a one-, two-, or multiple-part axle housing is provided on either side of the central axle body for accommodating at least one part of the mechanical drive train. Such axle housing extends the mechanically rigid and loadable steering axle construction outwardly toward the land wheels. Such extension enables the land wheels to be supported at the axle housings. Additionally, the part of the mechanical drive train located in the housings is protected against contamination and mechanical damage.

In the case of a two- or multiple-part, lateral axle housing, the invention provides for flexibly adjusting the length of the axle and, therefore, the track width. Such adjusting is implemented by replacing parts or changing the position thereof with respect to one another. For example, two housing parts that can be slid into one another are provided, where the housing parts are interconnected, e.g., screwed to one another, at the desired length.

As described above, hydraulic motors as well as electric motors can be used as drive motors, since advantages are achieved in the case of both motor types due to the central placement according to the invention. Both types of drive motors also are advantageous with respect to several expensive mechanical components, such as differentials, couplings, transmissions, etc.

In an embodiment, hydraulic radial piston motors are provided as drive motors. Radial piston motors are characterized by a compact design in combination with high torque. Also, a hydraulically controllable free wheel mechanism is provided in radial piston motors. The mechanism prevents compression losses from occurring in the free wheel mechanism during road travel in a simple control-related manner. The efficiency of the drive system is thereby increased.

This simple hydraulic control engages the all-wheel drive for work operation and disengage the all-wheel drive for road travel. A relatively high speed for road travel with high efficiency is therefore possible. The free wheel mechanism also provides advantages without the above-described features, such as the central placement of the motors.

Preferably, the mechanical drive train comprises a universal drive shaft. The universal drive shaft bridges the greatest portion of the distance between a centrally disposed drive motor and the land wheel to be driven by the motor can (in the mechanical drive train) in an energy-efficient, relatively simple, and reliable manner.

In combination with the above-described axle housing, the universal drive shaft is accommodated, in its entirety or in part, within the interior of a housing to protect against contamination and mechanical effects.

The invention also provides at least one reduction gear in the drive train. The reduction gear enables use of a smaller motor having a higher rotational speed in order to obtain the same tractive force. This increases the power density of the hydraulic components when a hydraulic motor is used. Compared to large, slowly rotating wheel motors, such structure advantageously results in a reduction of production costs and weight.

Advantageously, a planetary gear disposed on the outer side of the drive train is used as the reduction gear. Such a planetary gear is positioned in the wheel head or in the wheel hub of the land wheel to be driven, enabling the outer shell of the wheel head or the wheel hub itself to be coupled to the output drive of the transmission.

Preferably, a single-stage planetary gear is used. The single-stage planetary gear enables reduction of or reduces the thermal losses due to the heating of the lubricant, in particular during road travel, compared to a two- or multiple-stage transmission.

Combining an inventive steering axle with the central placement of the drive motors results in a drive train, which, as the connection between the drive motor and the land wheel or wheel hub, contains only one universal drive shaft and one transmission, in particular a planetary gear. Such a connection results in a simple and cost-favorable design reflecting a reduced complexity by easily using components from solely mechanical drive systems and drive trains.

The steering axle preferably is used in self-propelled agricultural machines, in particular harvesting machines or in tractors or similar vehicles.

### BRIEF DESCRIPTION OF THE DRAWINGS

Further features and advantages of the invention will become apparent from the description of embodiments that follows, with reference to the attached figures, wherein:

FIG. 1 shows a perspective representation of a steering axle according to the invention;

FIG. 2 shows a front view of a steering axle according to FIG. 1;

FIG. 3 shows a schematic cross-sectional representation of a steering axle according to FIG. 1; and

FIG. 4 shows an enlarged representation of the left half of the steering axle according to FIG. 3.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

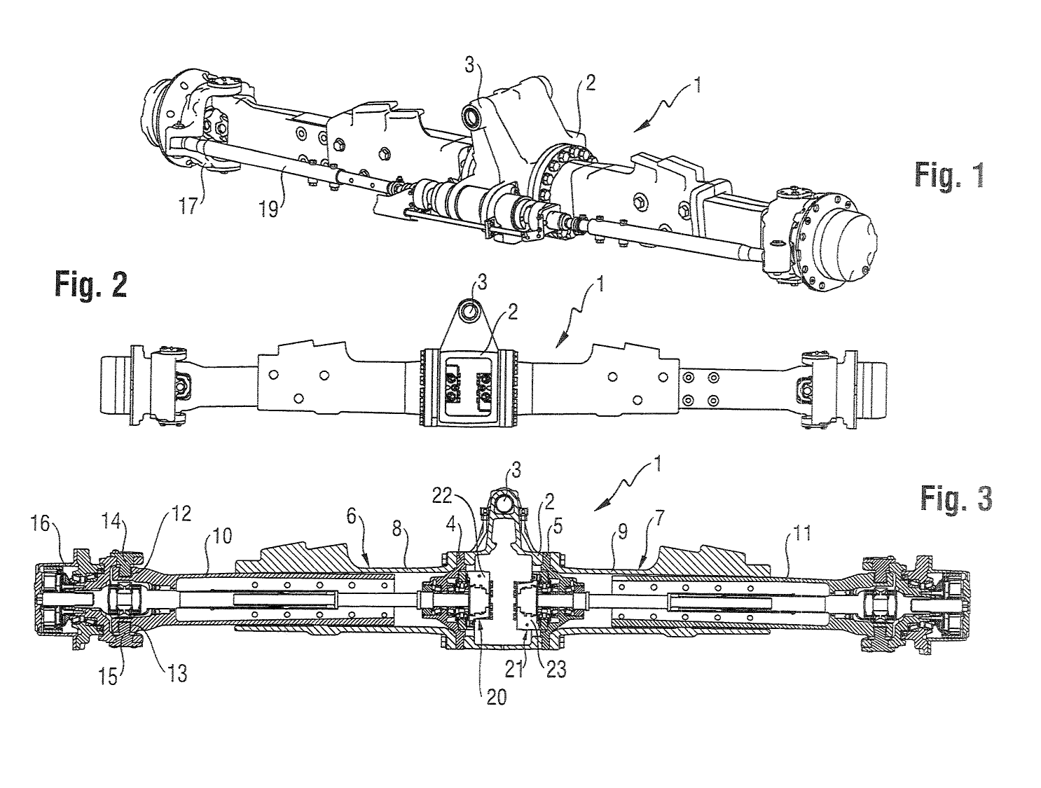

FIGS. 1-4 depict the invention in detail. As shown, the steering axle 1 comprises a central axle body 2, where the central axle body has a bearing receptacle 3 on the top side thereof for the pendular support of the steering axle 1.

A mounting flange 4, 5 is fastened on either side of the central axle body 2 and is adjoined by a two-part axle housing 6, 7, respectively. The axle housings 6, 7 comprise an inner housing part 8, 9, which is fixedly connected to the central axle body 2 (e.g., screwed thereto) and two outer housing parts 10, 11. Housing parts 10, 11 are slid into the housing parts 8, 9. Two receptacles 12, 13 for two bearing journals 14, 15, respectively, are located on the outer ends of the outer housing parts 10, 11. A wheel hub 16 is steerably supported at the outer housing parts 10, 11 by receptacles 12, 13.

The bearing journals 14, 15 are connected via a clamp 17, which is guided around the steering axle 1 on the outer side. The clamp functions as a steering lever and comprises a clamp receptacle 18 in which a track rod 19 is supported. The steering angle of the wheel hub 16 is adjusted in a routine manner (so not described in greater detail).

Two radial piston motors 20, 21 are located in the interior of the central axle body 2. The motors drive the two land wheels via the wheel hubs 16. The associated motor housings 22, 23 are slightly eccentric relative to the rotor axle of the motor. In the embodiment shown, the housings are each mounted on the mounting flange rotated by 180°. The housings, therefore, are located at different levels (see FIGS. 2 and 3).

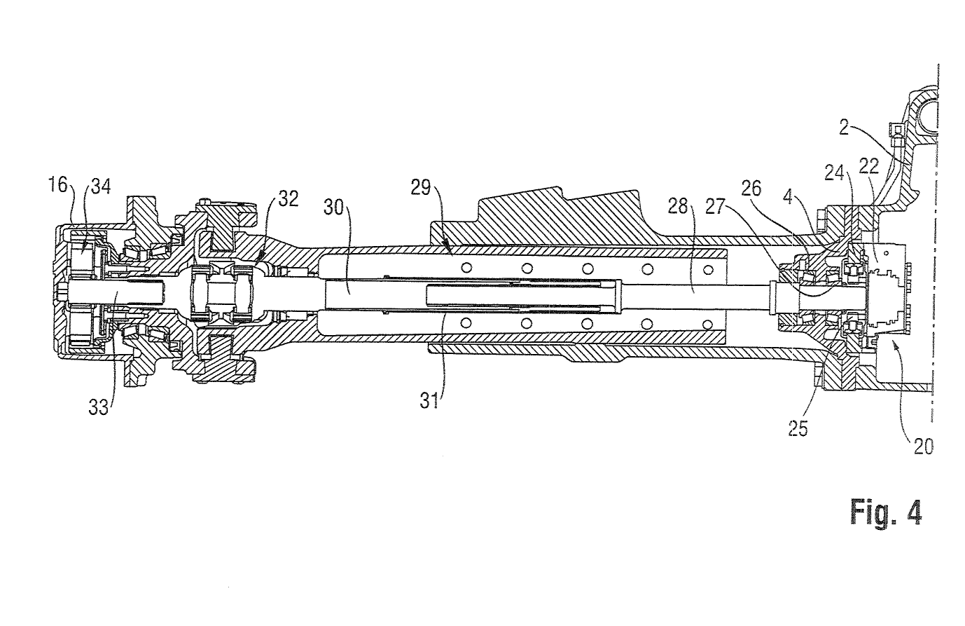

The drive is described in the following by reference to the left side of the steering axle 1 (FIG. 4). The right side has a similar design.

A cam track 24 of the radial piston motor 20 is attached to the motor housing 22. The radial pistons roll on this cam track and the rotor 25 having the piston rotates in the interior of this cam track. Two roller bearings 26, 27, in which an inner shaft 28 of a multiple-part universal drive shaft 29 is supported, are located in the mounting flange 4. The rotor 25 is fastened on the inner shaft 28 at the end and is therefore supported together with the inner shaft 28 in the roller bearings 26, 27.

The radial piston motor 20, together with the mounting flange 4, is removable from the central axle body 2. The motor is then accessible from the side of the motor end housing 22, 23.

The universal drive shaft 29 comprises the inner shaft 28 as well as an outer shaft 30. The outer shaft 30, together with the inner shaft 28, forms a telescopic universal drive shaft 29. A cover 31 is located in the region of the insertion of the inner shaft 28 into the outer shaft 30. The cover encapsulates and therefore protects against contamination. The running surfaces of the inner shafts 28 and the outer shafts 30 (which are insertable into one another in a telescopic manner), preferably include a slide coating. Such a universal drive shaft is advantageous in solely mechanical drives.

A universal joint 32 is located on the outer end of the outer shaft 30. The joint 32 enables torque from the universal drive shaft 29 to be transferred in a manner known per se to the drive shaft 33 of a planetary gear 34.

The planet carrier of the planetary gear 34 forms the output side of the planetary gear 34 and is therefore connected to the particular wheel hub 16.

The steering axle 1 offers the advantage that, in the installed state, the steering axle 1 is rigid and is can be fastened on the vehicle in a pendular manner via the bearing receptacle 3.

Drive motors in the form of radial piston motors 20, 21 are accommodated in the center of the central axle body 2, are easy to connect, and are mechanically connected to the particular wheel hub 16 via an above-described drive train.

The mechanical drive train is completely enclosed by the housing parts 8, 9 and 10, 11 and, therefore, protected against contamination and external mechanical damage. The two-part design of the axle housing 6, 7, allows the length of the steering axle 1 and, therefore, the track width to be adjusted. Preferably, the inner housing part 8, 9 is screwed together with the outer housing part 10, 11 (respectively), in the desired position.

Due to the variable-length design of the universal drive shaft 29, the track width is changeable even when the axle 1 is fully installed.

The radial piston motors 20, 21 comprise a free wheel mechanism. The free wheel mechanism allows the drive of the steering axle 1 to be engaged for work operation and disengaged for road travel.

The axle housings 6, 7, are easily mounted in the central axle body 2 via the intermediate flanges 4, 5, and are hydraulically connected in the center of the central axle body 2. This eliminates a need to install a complex and susceptible hydraulic connection outwardly to the wheel hubs 16. The mechanical drive train facilitates efficient transfer of torque from the central axle body 2 to the wheel hubs 16. Due to the single-stage design of the planet gear 34, the thermal loss that occurs in the road-travel mode with the motors in neutral is held within limits despite a relatively high road-travel speed, thereby reducing losses.

The inventive steering is easily produced and mounted in a highly flexible manner and simultaneously permits engageable all-wheel drive operation of the steering axle.

The following list of reference signs of various elements mentioned above is included (as follows), for ease of explanation:

### LIST OF REFERENCE CHARACTERS

1 steering axle
2 central axle body
3 bearing receptacle
4 mounting flange
5 mounting flange
6 axle housing
7 axle housing
8 inner housing part
9 inner housing part
10 outer housing part
11 outer housing part
12 receptacle
13 receptacle
14 stub axle
15 stub axle
16 wheel hub
17 clamp
18 rod receptacle
19 track rod
20 radial piston motor
21 radial piston motor
22 motor housing
23 motor housing
24 cam track
25 rotor
26 roller bearing
27 roller bearing
28 inner shaft
29 universal drive shaft
30 outer shaft
31 cover
32 universal joint
33 drive shaft
34 planetary gear

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A steering axle (1) for agricultural vehicles comprising
at least two drive motors (20, 21) for at least two land wheels on either side of the steering axle (1),
wherein the at least two drive motors (20, 21) are disposed next to one another substantially in the center between the land wheels, and
wherein a mechanical drive train (29, 33, 34) is positioned between the drive motor (20, 21) and the land wheel on both sides.

2. The steering axle according to claim 1, wherein the agricultural vehicle is any of a self-propelled harvesting machine, a tractor and the like.

3. The steering axle according to claim 1, wherein the at least two drive motors (20, 21) are fastened at a common central axle body (2).

4. The steering axle according to claim 1, wherein the central axle body (2) comprises a bearing device (3) for fastening the entire steering axle (1) on the vehicle in a pendular manner.

5. The steering axle according to claim 1, wherein an intermediate flange (4) is provided between at least one drive motor (20, 21) and the central axle body (2).

6. The steering axle according to claim 1, wherein a substantially closed axle housing (6, 7) for accommodating at least a portion of the mechanical drive train (29, 33, 34) is provided on either side of the central axle body (2).

7. The steering axle according to claim 1, wherein at least one axle housing (6, 7) has a two- or multiple-part design.

8. The steering axle according to claim 1, wherein the drive motors (20, 21) are hydraulic or electric motors.

9. The steering axle according to claim 1, wherein the drive motors are hydraulic radial piston motors.

10. The steering axle (1) according to claim 1, wherein the drive motors (20, 21) are formed as radial piston motors comprising a hydraulically controllable free wheel mechanism.

11. The steering axle according to claim 1, wherein the mechanical drive train comprises a variable-length universal drive shaft or a universal drive shaft having a fixed length.

12. A steering axle for agricultural vehicles, comprising
a mechanical drive train for transferring torque between a drive motor (20, 21) and a free wheel mechanism,
wherein the mechanical drive train (29, 32, 34) has a variable-length universal drive shaft (29) having at least two partial shafts (28, 30),
wherein the at least two partial shafts (28, 30) are insertable into one another in a telescopic manner, where at least one of the shafts has a slide coating and where a cover (31) is provided for encapsulating part of one partial shaft withdrawn from the other partial shaft.

13. The steering axle according to claim 12, wherein at least one reduction gear (34) is provided in the drive train.

14. The steering axle according to claim 12, wherein the planetary gear (34) is disposed on the outer side of the drive train.

15. The steering axle according to claim 12, wherein the planetary gear (34) is disposed in the wheel hub (16) of the land wheel.

16. An agricultural vehicle comprising at least one steering axle steering axle (1) of claim 12.
